(19) United States
(12) Patent Application Publication
(10) Pub. No.: US 2018/0315140 A1
(43) Pub. Date: Nov. 1, 2018

(54) COMMISSION INADVANCE AND FINANCING SOFTWARE

(71) Applicant: NITISH LAL, Brampton (CA)

(72) Inventor: NITISH LAL, Brampton (CA)

(21) Appl. No.: 15/497,746

(22) Filed: Apr. 26, 2017

(51) Int. Cl. G06Q 50/16; G06Q 40/02

(52) U.S. Cl. CPC G06Q 50/167; G06Q 40/025

(57) ABSTRACT

The present invention is a method for reviewing a mortgage documents for a real estate property and providing a cash deposit to a purchaser and an advance payment to the realtors. The method comprises of engaging the realtors having new listings of the real estate properties; providing a geospatial analysis report and a comparison report for the real estate properties; obtaining mortgage files from the buying realtors or the purchasers; collecting and analyzing statistical and financial data from the real estate properties, and providing the mortgages and the commission advance payments to accepted mortgage files.

### FIELD OF THE INVENTION

The present invention relates generally to computer programs, and especially to mortgage financing and commission/income financing software.

### BACKGROUND OF THE INVENTION

A portion of a sale price of a real estate is usually paid to a listing realtor and a buyer's realtor as their commission for selling the real estate. The realtors get paid when the real estate closes the deal based on a contract between a real estate owner and a buyer. On the closing day (the day when the legal possession of the property is changed to a buyer by a lawyer), the real estate agents get paid for the services that they provided. The time between the day of signing an agreement to purchase/sell a property and the closing day can be very long; several months. The realtors do not get paid during all this period. This may result in a significant reduction in realtors business activities due to cash flow problems.

The present invention solves the problem of reduced/stalled cash-flow for real estate agents and provides a solution of accelerated income in order to help the market and grow the business of real estate agents.

The present invention solves the problem of identifying a qualified financing agent to arrange the appropriate funds to successfully close the real estate transaction.

### SUMMARY OF THE INVENTION

In one embodiment, the present invention is a computer-implemented platform for reviewing a mortgage document for a real estate property and arranging mortgage financing, acting as a mortgage agent for the purchaser and an advance payment to the realtor. The program comprises of:
a computer-implemented program to engage a plurality of realtors having new and old listings of a plurality of real estate properties;
a computer-implemented program to collect and provide a geospatial analysis report for the purchasing of real estate properties;
a computer-implemented program to provide a comparison report for the real estate properties;
a computer-implemented program to collect and analyze a plurality of mortgage documents from a plurality of purchasers; and
a computer-implemented program which provides a commission advance or security deposit to the realtors and cash deposit to the real estate purchasers of the accepted mortgage files, in exchange of an exclusive right to provide financial services, acting as a mortgage agent for said purchaser, whereby the computer-implemented platform controls the programs by a computer network.

In another embodiment, the present invention is a computer based method for performing real estate transactions, the present invention comprises below steps:
engaging the realtors having new and old listings of the real estate properties
providing a geospatial analysis report for the real estate properties;
providing a comparison report for the real estate properties;
obtaining mortgage files from the purchasers;
collecting statistical and financial data from the real estate properties;
analyzing statistical and financial data;
arranging and assessing to obtain the mortgages to accepted mortgage files, and
providing the commission advance payments for the accepted mortgage files in exchange of an exclusive right to provide financial services for said purchaser, and whereby the method controls the steps via a computer network.

The present invention aids in purchasing real estate as it arranges financing for the mortgage. The present invention functions with a software that networks with real estate brokerages, keeps record of business contacts and completes a thorough analysis of the mortgage file.

The present invention solves the need of identifying mortgage clients/files that are more likely to be successfully financed by the mortgage broker. The present invention solves the need of engaging real estate brokerages whom have newly listed properties and are likely to be clients of the present invention.

The present invention solves the issue of generating sales and building a strong business relationship with real estate brokerages and real estate purchasers.

The present invention satisfies the need of advancing commission to real estate brokerages, securing a payment for the client's (home purchaser's) to obtain the exclusive rights of the mortgage file from purchaser.

The present invention has connected two separate industries; finance industry and real estate industry. It solves the problem of funding and consulting the realtor, obtaining mortgage client sales, conducting analyses and calculations needed for successfully closing the real estate transaction. The present invention helps to discover potential clients and partners.

The present invention performs an automated engagement to the real estate brokerages and keeps the contacts information for the future business relationship.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram of the present invention to engage the realtors;

FIG. 2 shows a schematic diagram of a mortgage engine of the present invention;

FIG. 3 shows a schematic diagram of a mortgage engine of the present invention;

FIG. 4 shows a schematic diagram of the present invention, and

FIG. 5 shows a schematic diagram of the present invention.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The method and computer program disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

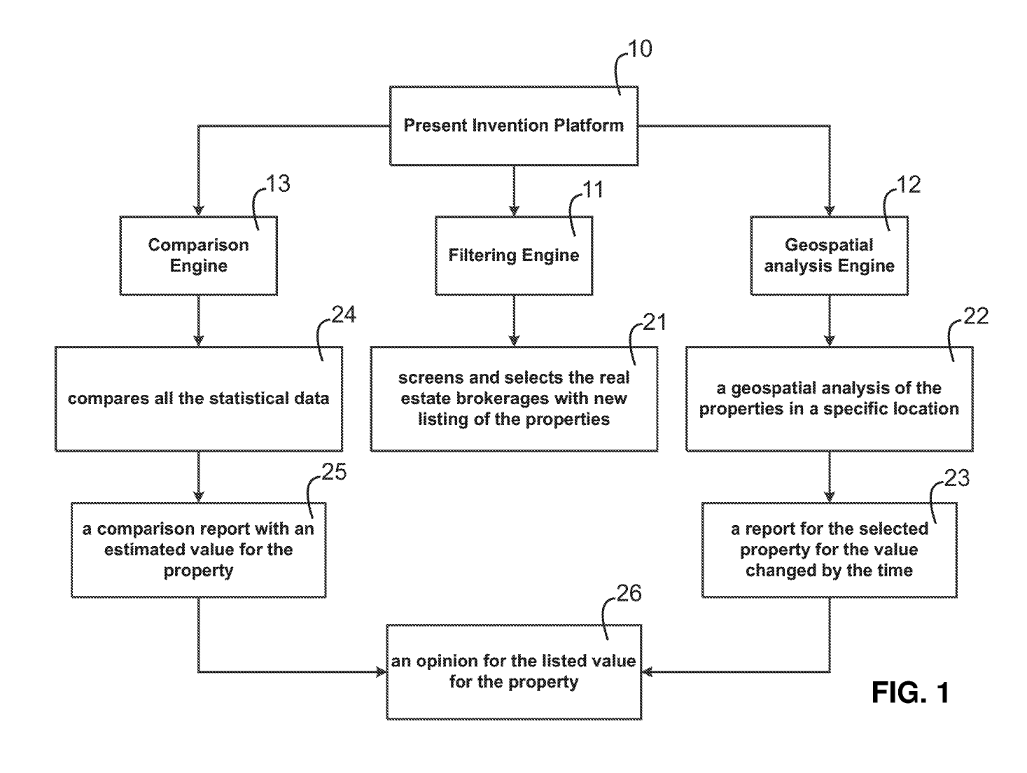

As shown in FIG. 1, the present invention engages the real estate brokerages obtaining new listings with the present invention platform 10 by a filtering engine 11. The filtering engine 11 of the present invention screens and selects the real estate brokerages with new property listing 21. A geospatial analysis engine 12 of the present invention prepares a geospatial analysis report of the properties 22 in a specific location.

The geospatial analysis report comprises of a report which gathers, displays, and manipulates of images, GPS information, satellite photography and historical data based on a street address and a postal code of the real estate property. The geospatial analysis report provides sufficient information to the buyers to have better understanding of the real estate property in terms of locations.

The geospatial analysis engine 12 collects all the data from the previously sold properties and prepares a report for the selected property 23 (value by the time) to give a better understanding of the value changes in the time. The report 23 can be used by other realtors or even purchasers to compare the listed value by the ones suggested by the geospatial analysis engine 12.

The present invention platform 10 also has a comparison engine 13 to provide a comparison report 25 for a selected property, which is in the market, to be compared by the similar properties in the same neighborhood. The comparison engine 13 compares all the statistical data 24, which are available in the specific location, to give a comparison report 25 with an estimated value for the property in the selected location. The estimated value for the property in the market is also compared by the listing value. From the gathered data by the geospatial analysis engine 12 and the comparison engine 13, the present invention platform 10 provides an opinion for the listed value for the property 26 to be reviewed by the realtors and the property purchasers.

The geospatial analysis engine and comparison engine are used to engage a plurality of real estate brokerages obtaining new listings with the present invention platform. The geospatial analysis engine and comparison engine provide useful information for the real estate market.

After a real estate purchaser has found the property, an offer to purchase is given to the vendor. The offer to purchase includes all the details of the sale. The realtor presents the offer to the vendor or vendor's realtor. If the vendor accepts the offer, the deal is concluded and the buyer moves on to the next step in the buying process.

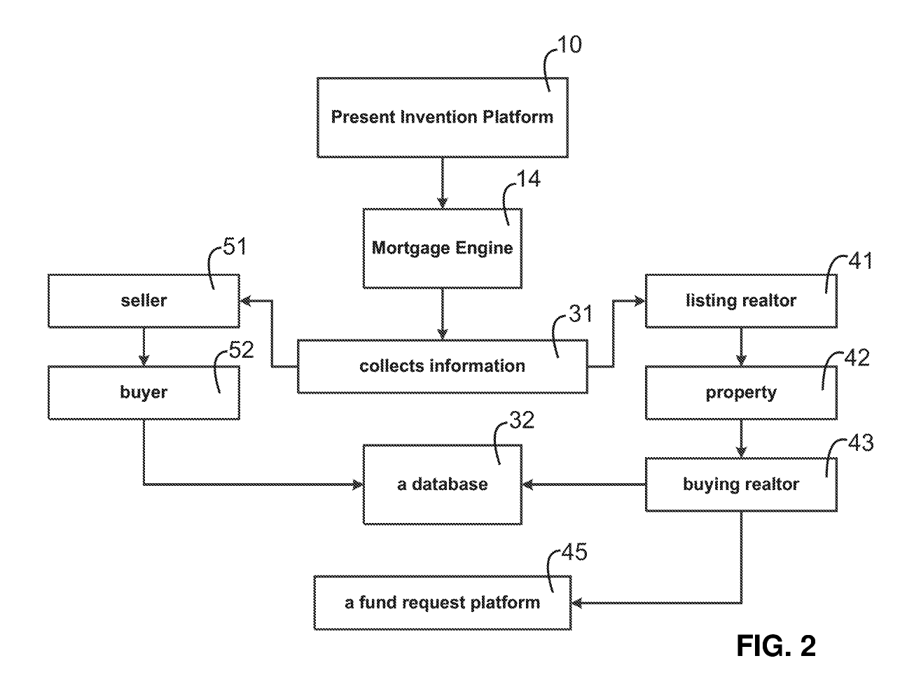

As shown in FIG. 2, the platform 10 in the present invention obtains further information about the listing realtor (selling realtor) 41, the subject property 42 and the buying realtor 43 for a mortgage engine 14. The platform 10 of the present invention collects this information 31 into a database 32. The realtor of the purchaser (buying realtor) 43 can request a fund (commission advance) through a fund request platform 45 (fund me form platform) once the offer to purchase has been accepted.

Again as shown in FIG. 2, once obtaining the mortgage file, the platform 10 inputs the client's (real estate purchasers) data 51, 52 into its database to perform studies and analyses to determine whether the file can be successfully executed.

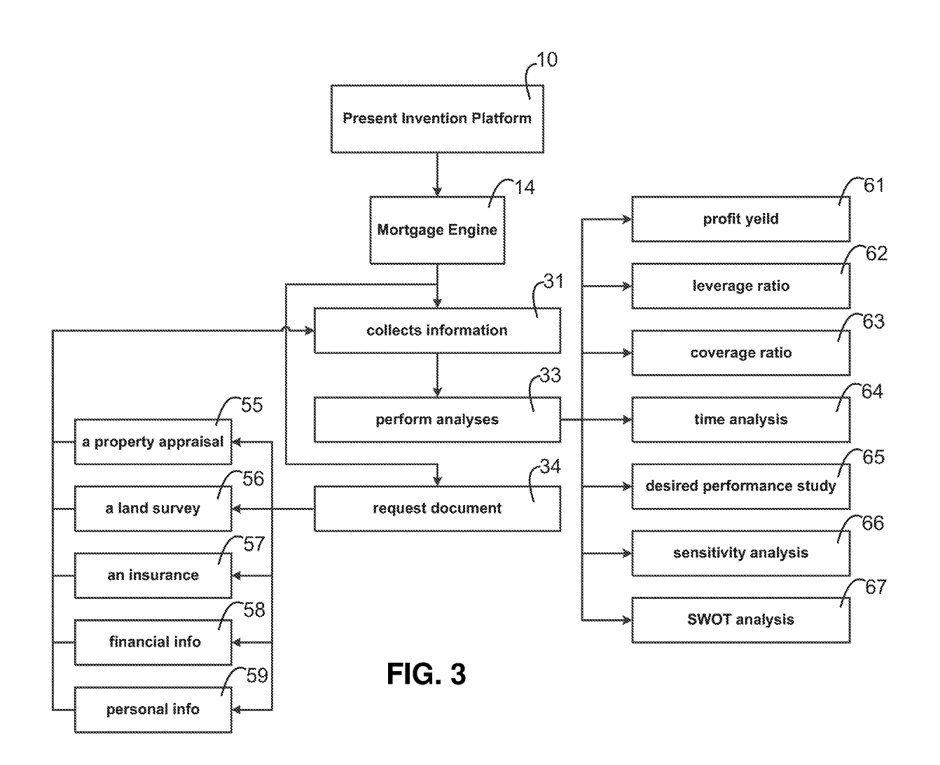

As shown in FIG. 3, the mortgage engine 14 collects information 31 and performs some statistical and financial analysis 33. The analysis comprises of a profit yield 61 for the present platform, the companies leverage ratios 62 and coverage ratios 63, time analysis on real estate brokers 64, desired performance study 65, sensitivity analysis 66, SWOT (strength, weakness, opportunity and threat) analysis 67 on file and client and a repeat methodology.

Once the buying realtor requested a fund (commission advance) from the fund request platform, the mortgage engine 14 will verify the buyer's financial information and put together all the documents needed to complete the mortgage application. As shown in FIG. 3, the mortgage engine 14 may request some documents 34 from the buyer to get a property appraisal 55, a land survey 56, a title insurance 57, financial information 58 and personal information 59. The present invention aids in purchasing real estate as it arranges financing for a mortgage by the mortgage engine 14.

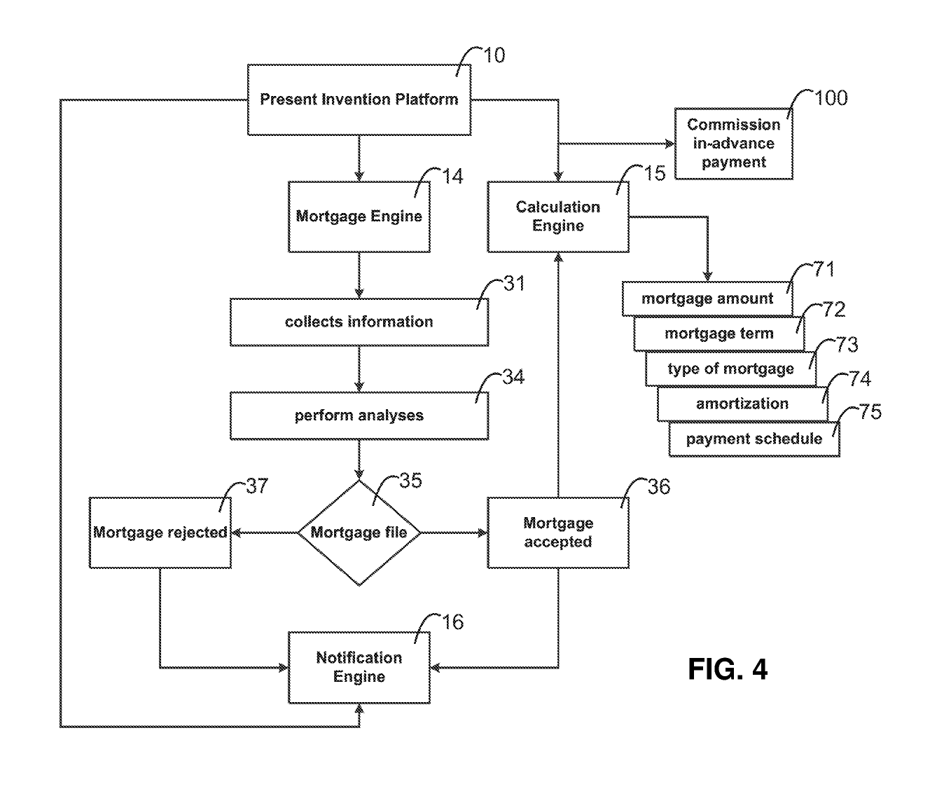

As shown in FIG. 4, the present platform 10 performs data analysis 34 to complete the mortgage application 35. If the mortgage application 35 is accepted 36, the present platform 10 notifies the buying realtor by a notification engine 16 that the commission advance or cash deposit is available in exchange to exclusive arrange financing and to finalize the real estate purchase. If the mortgage application 35 is rejected 37, the buying realtor is notified by the notification engine 16.

As shown in FIG. 4, a calculation engine 15 provides a mortgage amount 71, a mortgage term 72, type of mortgage 73, amortization 74, and the payment schedule 75. The present platform 10 provides a security/cash payment to the purchaser in exchange of an exclusive agreement to act as the mortgage agent for the purchaser. The calculation engine 15 of the present platform 10 also calculates the real estate brokerages commission and has an option to provide the realtors commission payment 100 in-advance of the closing day.

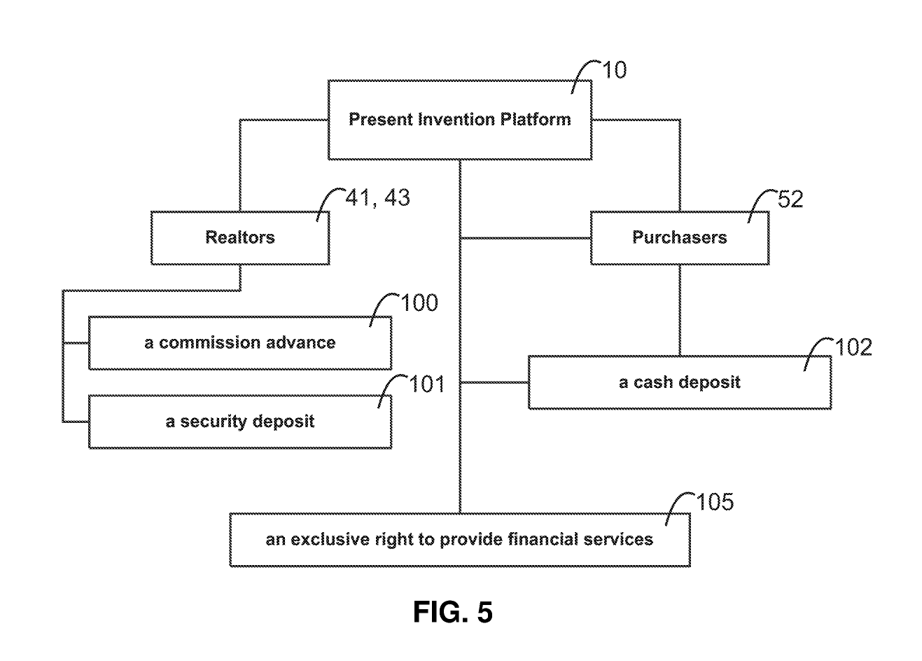

As shown in FIG. 5, the present invention platform 10 as a computer-implemented program provides a commission advance 100 or a security deposit 101 to the realtors 41, 43 and a cash deposit 102 to the real estate purchasers (buyers) 52 of the accepted mortgage files, in exchange of an exclusive right to provide financial services 105 and acting as a mortgage agent for the purchaser 52.

The present invention performs the technical analyses required to be aware of the success of the commission advance, in exchange for the mortgage file of the purchaser.

The present platform can be used by realtors, real estate brokerages, real estate investment trusts (REITS), banks/lenders, mortgage agents, finance consultants, real estate investors and home buyers.

The present platform can be operated as a mobile application in a mobile devices or as a web application on a computer.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A computer-implemented platform for reviewing mortgage documents for a real estate property and providing a cash deposit to a purchaser and an advance payment to realtors in exchange of an exclusive right to provide financial services, said computer-implemented platform comprises:
a) a computer-implemented program to engage a plurality of realtors having new or old listings of a plurality of real estate properties;
b) a computer-implemented program to collect and provide a geospatial analysis report for said real estate properties;
c) a computer-implemented program to provide a comparison report for said real estate properties;
d) a computer-implemented program to analyze a plurality of mortgage files from a plurality of buying realtor or a plurality of purchaser, and
e) a computer-implemented program to provides the mortgages, security deposit and commission advance payments for the accepted mortgage files in exchange of an exclusive right to provide financial services for said purchaser;
whereby said computer-implemented platform controls said programs via a computer network and collects data in a database.

2. The computer-implemented platform of claim 1, wherein said geospatial analysis report comprises of a report which gathers, displays, and manipulates of images, GPS information, satellite photography and historical data based on a street address and a postal code of said real estate property.

3. The computer-implemented platform of claim 1, wherein said geospatial analysis report further provides a financial data from previously sold properties in a same neighborhood or with same details.

4. The computer-implemented platform of claim 1, wherein said comparison report comprises of a report for said real estate property compared by similar properties in the same neighborhood.

5. The computer-implemented platform of claim 1, wherein said comparison report further compares all the statistical data in a same location to provide an estimated value for said real estate property.

6. The computer-implemented platform of claim 1, wherein said comparison report further provides an opinion for said real estate property to be reviewed by the realtors and the property purchasers.

7. The computer-implemented platform of claim 1, wherein said computer-implemented program to analyze collects and performs statistical and financial analysis based on a profit yield, a leverage ratio, a coverage ratio, a time analysis, a performance study, a sensitivity analysis, and SWOT analysis.

8. The computer-implemented platform of claim 1, wherein said platform further has a notification engine to notify to the realtors and the purchaser an acceptance of the mortgage file.

9. The computer-implemented platform of claim 1, wherein said platform further has a calculation engine to provide a mortgage amount, a mortgage term, type of mortgage, an amortization, and the payment schedule.

10. The computer-implemented platform of claim 1, wherein said platform further provides networking services for said realtors.

11. A method for reviewing a mortgage document for a real estate property, providing a cash deposit to a purchaser and an advance payment to realtors comprises steps of:
a) engaging a plurality of realtors having new listings of a plurality of real estate properties;
b) providing a geospatial analysis report for said real estate properties;
c) providing a comparison report for said real estate properties;
d) obtaining a plurality of mortgage files from a plurality of buying realtor or a plurality of purchaser;
e) collecting statistical and financial data from said real estate properties;
f) analyzing statistical and financial data;
g) providing a plurality of mortgages to accepted mortgage files, and
h) providing a plurality of commission advance payments for the accepted mortgage files in exchange of an exclusive right to provide financial services for said purchaser;
whereby said method controls said steps via a computer network.

12. The method for reviewing a mortgage document of claim 11, wherein said geospatial analysis report comprises of a report which gathers, displays, and manipulates of images, GPS information, satellite photography and historical data based on a street address and a postal code of said real estate property.

13. The method for reviewing a mortgage document of claim 11, wherein said geospatial analysis report further provides a financial data from previously sold properties in a same neighborhood or with same details.

14. The method for reviewing a mortgage document of claim 11, wherein said comparison report comprises of a report for said real estate property compared by similar properties in the same neighborhood.

15. The method for reviewing a mortgage document of claim 11, wherein said comparison report further compares all the statistical data in a same location to provide an estimated value for said real estate property.

16. The method for reviewing a mortgage document of claim 11, wherein said comparison report further provides an opinion for said real estate property to be reviewed by the realtors and the property purchasers.

17. The method for reviewing a mortgage document of claim 11, wherein said analyzing statistical and financial data collects and performs statistical and financial analysis based on a profit yield, a leverage ratio, a coverage ratio, a time analysis, a performance study, a sensitivity analysis, and SWOT analysis.

18. The method for reviewing a mortgage document of claim 11, wherein said method further has a notification step to notify to the realtors and the purchaser an acceptance of the mortgage file.

19. The method for reviewing a mortgage document of claim 11, wherein said method further has a calculation step to provide a mortgage amount, a mortgage term, type of mortgage, an amortization, and the payment schedule.

20. The method for reviewing a mortgage document of claim 11, wherein said method further provides networking services for said realtors.
